(19) United States
(12) Patent Application Publication
(10) Pub. No.: US 2015/0227690 A1
(43) Pub. Date: Aug. 13, 2015

(54) SYSTEM AND METHOD TO FACILITATE PATIENT ON-BOARDING

(71) Applicant: Xerox Corporation, Norwalk, CT (US)

(72) Inventor: Robert J. St. Jacques, Fairport, NY (US)

(73) Assignee: Xerox Corporation, Norwalk, CT (US)

(21) Appl. No.: 14/178,382

(22) Filed: Feb. 12, 2014

(51) Int. Cl. G06F 19/00; G06T 7/00; G06K 9/00

(52) U.S. Cl. CPC G06F 19/322; G06F 19/328; G06K 9/00456; G06K 9/00463; G06T 7/0081; G06T 2207/30176

(57) ABSTRACT

An electronic medical record creation system receives an image of a patent identification card, as well as an image of a healthcare insurance card. The system processes the image of the identification card to extract the patient name, and it processes the image of the healthcare insurance card to extract names of one or more covered persons. The system determines which of the covered persons' name corresponds to the name of the patient, and it extracts a corresponding insurance identification number from the image of the healthcare insurance card. The system creates an electronic patient record for the patient that includes the identified covered person name and the insurance identification number.

### BACKGROUND

Despite technology advancements in healthcare, patient on-boarding remains an antiquated, manual data capture process that frustrates both the patient and the healthcare provider. It is common practice in hospital management systems to manually enter a patient's insurance information into the patient record during the patient on-boarding process. The manual process generally involves brief patient interviews or forms filled out by a patient, for receiving the desired information (e.g. first and last name, date of birth, etc.). The information is then manually entered into the patient's record. Furthermore, in order to get paid for services provided to a patient, the provider must submit a claim to the payer (e.g., the patient's insurance company) that covers the patient's health care costs. The claim submitted must contain correct patient subscriber information. However, a significant percentage of claims are rejected by the payer because of human errors made in manually entering the patient insurance information during the patient on-boarding process, and must be resubmitted with corrections. This can cause long delays (up to about 120 days) between the date of services provided and the date of receiving payment. Overall, the complete process is labor-intensive and therefore costly.

Some common errors may include incorrect patient information on the claim such as wrong or misspelled patient name, an incorrect subscriber ID, or a subscriber ID that does not match patient name on the claim.

While some hospital management systems that use Electronic Medical Records (EMR) may require scanning of a patient's photo ID and the insurance card, the information from the cards itself is still entered manually after visual inspection by a staff member. Errors may also occur because insurance companies may print multiple subscriber ID numbers on the same insurance card for a primary subscriber and dependents, where all the patients have a different subscriber IDs. For example, errors may occur when subscriber ID for another patient listed on the same card is entered. Furthermore, if the insurance payer uses an electronic system for receiving bills from the provider, a single error would result in rejection of the claim. Moreover, even if the error can be easily detected or corrected by the payer, there is no incentive to do so.

This document describes methods and systems that are intended to address the issues discussed above and/or other issues.

### SUMMARY

In an embodiment, in a method of creating a patient record, an imaging device receives an image of an identification card. The identification card may be, for example, a driver's license, a prescription card, a Medicare card, a Medicaid card, a medical identification card, or a business card. The imaging device also receives an image of a healthcare insurance card that bears multiple covered person names and, for each covered person name, an insurance identification code. One or more processors will extract a name of a patient from the image of the identification card, extract the covered person names from the image of the healthcare insurance card, and determine which of the covered person names corresponds to the name of the patient. The one or more processors will select the determined covered person name as a current patient, and extract the insurance identification code that corresponds to the current patient from the image of the healthcare insurance card. In response to selecting the determined covered person name as the current patient and extracting the insurance identification code that corresponds to the current patient, the one or more processors will automatically create an electronic patient record that includes the name and insurance identification code for the current patient. Optionally, the system may display the electronic patient record to the patient and prompt the patient to verify the electronic patient record.

Optionally, when determining which of the covered person names corresponds to the patient name, the system may determine that at least one of the covered person names is not an exact match with the name of the patient. If so, it may map a portion of the covered person name to a name variant, replace the mapped portion of the covered person name with the name variant, and determine whether the name of the patient matches the covered person name with the name variant.

As another option, when determining which of the covered person names corresponds to the patient name, the system may identify at least two of the covered person names as possible matches with the name of the patient, extract a date of birth for the patient from the image of the identification card, access an external data source to identify a record that includes both the date of birth and one of the possible match covered person names; and use the covered person name from the identified record as the name of the current patient.

As an additional option, when determining which of the covered person names corresponds to the patient name, the system may: (i) identify at least two of the covered person names as possible matches with the name of the patient; (ii) extract a date of birth and a sex for the patient from the image of the identification card; (iii) access an external data source to identify a record that includes the date of birth, the sex and one of the possible match covered person names; and (iv) use the covered person name from the identified record as the name of the current patient.

In some embodiments, the system may identify a key in the image of the identification card. If so, it may use the key to retrieve corresponding patient information from a database, and it may incorporate the retrieved information into the electronic patient record. In addition, it may use the key to cross reference a look up table to identify a type of insurance information retrieved. It also may include the type of insurance information retrieved in the electronic patient record.

In another embodiment, in a method of creating a patient record, an imaging device receives an image of an identification card, as well as an image of a healthcare insurance card. The healthcare insurance card bears one or more covered person names and, for each covered person name, an insurance identification code. One or more processors will extract a name of a patient from the image of the identification card, along with one or more covered person names from the image of the healthcare insurance card. The processors will determine whether one or more of the covered person names corresponds to the name of the patient and select the determined covered person name as a current patient. When determining whether one or more of the covered person names corresponds to the name of the patient, the processors will do at least one of the following: (i) for at least one of the covered person names, map a portion of the covered person name to a name variant, replace the mapped portion with the name variant, and determine whether the name of the patient matches that covered person name with the name variant; or (ii) extract a date of birth for the patient from the image of the identification card, access an external data source to identify a record that includes both the date of birth and one of the possible match covered person names, and use a name from the identified record as the name of the current patient. The processors will then extract, from the image of the healthcare insurance card, the insurance identification code that corresponds to the current patient. In response to selecting the determined covered person name as the current patient and extracting the insurance identification code that corresponds to the current patient, the processors will automatically create an electronic patient record that includes the name and insurance identification code for the current patient.

### BRIEF DESCRIPTION OF THE DRAWINGS

FIG. 1 illustrates a prior art method for patient on-boarding.

FIG. 2 illustrates an example of a patient insurance identification (ID) card.

FIG. 3 illustrates a method for patient on-boarding according to an embodiment in accordance with the current disclosure.

FIG. 4 illustrates a method for retrieving patient subscriber ID from an insurance card according to an embodiment in accordance with the current disclosure.

FIG. 5 illustrates a method of matching a patient's name in a patient ID and insurance card according to an embodiment in accordance with the current disclosure.

FIG. 6 illustrates a block diagram of various hardware components that may be included in a system according to various embodiments.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

For purposes of the discussion below “patient on-boarding” is the process of receiving and assembling information about a patient in a healthcare system. It may involve new as well as existing patients. It may involve creating new patient records or updating existing records. The patient information may include, for example, patient name, address, social security number, health insurance type, health insurance subscriber and/or group code and other related health insurance information, such as a scanned image of a patient's health insurance card (one or both sides).

An “imaging device” refers to any device capable of optically viewing an object and converting an interpretation of that object into electronic signals. Examples of an imaging device may include a camera, a card scanner, a barcode scanner, a card reader, a magnetic strip reader, and the like.

A patient ID card refers to a portion of paper or other substrate that contains patient information, physician information, pharmacy information, prescription information and/or the like. For example, an acceptable ID card may be a driver's license, a prescription card, a Medicare card, a Medicaid card, a medical identification card, a business card and/or the like. Additional and/or alternate cards may be used within the scope of this disclosure. Note that a patient ID card does not include patient medical insurance information.

A patient insurance card refers to a portion of paper or other substrate that contains patient medical insurance information. A patient's medical insurance information may include subscriber ID, insurance group number, insurance provider name, insurance provider contact information, co-pay and/or the like.

A covered person refers to a person covered for medical services under a health insurance plan, and has an assigned subscriber ID.

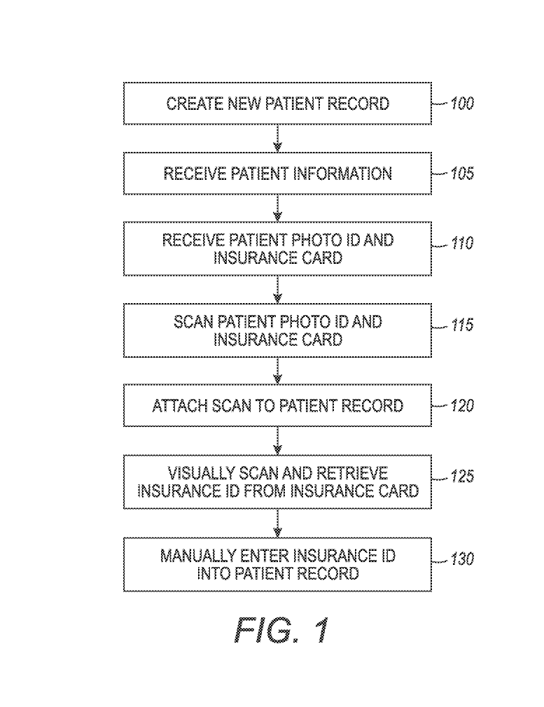

As shown in FIG. 1, in a prior art patient on-boarding process employed by a healthcare provider, a staff member creates a new patient record at step 100. Next, at step 105, the staff member asks the patient a series of questions regarding patient (e.g., name, address, social security number, etc.). This may also be performed by having the patient manually enter such information on a set of paper forms. This information is then manually entered into the provider's system. At steps 110 and 115, the patient photo ID and insurance card are received and scanned. The scanned copies are attached to the patient record at step 120, and visually inspected for more patient information which is manually entered into the patient record. The process is labor intensive and prone to expensive errors.

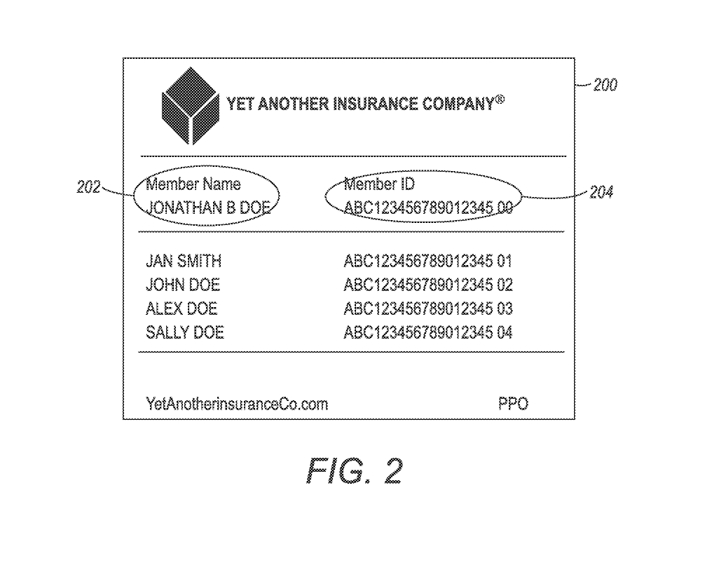

Errors may also occur when a single insurance card has multiple names and subscriber IDs listed on it as shown in FIG. 2. As FIG. 2 indicates that a healthcare insurance card 200 may include an insurance subscriber name 202 and member identification code 204. The member identification code may be a policy number, group number, and/or other unique identifier by which the insurance provider may identify the person. Note that as used in this document, a card may be any substrate on which a healthcare insurance subscriber's name and insurance identifier are imprinted. The subscriber may be the primary insurance policyholder, but one or more family members of the subscriber also may be covered by the insurance. If so, the card also may list the covered family members and their policy numbers.

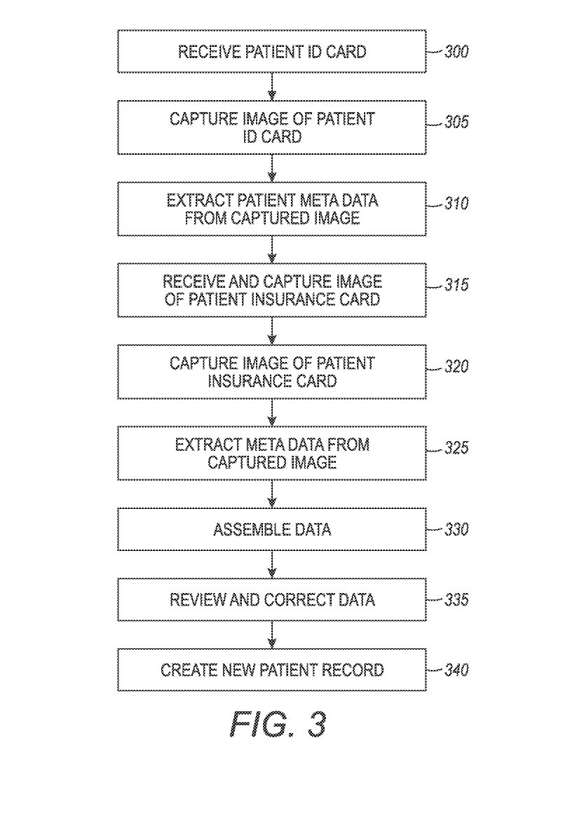

FIG. 3 illustrates an embodiment of a patient on-boarding process according to the principles of the current disclosure. As illustrated by FIG. 3, at step 300 an identification (ID) card from a patient may be received and an image of the ID card may be captured at step 305. In some embodiments, the ID card may be received by a staff member. The staff member then may cause an image capture device to capture an image of the ID card. In certain other embodiments, the patient may be asked to present the ID card to an image capture device directly. An ID card is any general card that is does not contain healthcare insurance information, but instead is one that is typically used for general identification purposes, such as a driver's license, passport, or other identification card.

In some embodiments, the image capture device may include a barcode scanner, a card reader, a camera, or a card scanner. The image may be captured of the complete ID card, or a portion of an ID card. It will be understood to those skilled in the art that prior art image capturing modules may be modified for use with the present disclosure. In certain embodiments, the captured image may be stored into a patient record for future reference.

A patient ID card may include human readable information, a magnetic strip, barcode, memory device, or other information bearing means. An image may be captured by scanning a barcode on the ID card, photographing the ID card, scanning the ID card, swiping a magnetic strip on the ID card or otherwise reading the ID card. Additional and/or alternate image recording techniques may be used within the scope of this disclosure.

Next at step 310, corresponding patient meta data may be extracted from the image captured at step 305. The patient meta data may include patient's full name, address, contact number and other pertinent information, such as date of birth, sex and social security number. Meta data may be extracted or parsed from a captured image using known techniques such as image processing and optical character recognition (OCR), or any other suitable pattern recognition technique now or hereafter known to those of skill in the art. A digital bitmap corresponding to scanned image may be processed using any OCR now or hereafter known to those of skill in the art. Optical character recognition may be any conventional optical character recognition process such as that described in U.S. Pat. No. 6,396,951, the disclosure of which is incorporated herein by reference. The system may use OCR to convert each bit map into text data. For example, the image of the scanned photo ID card may be interrogated using conventional OCR to translate the image into a searchable ASCII file of data fields. One or more fields of text data may be extracted from the card. In an embodiment, each field may correspond to a label, for example, name, address, social security number, and/the like. Alternatively, an image may include a machine readable glyph (such as a barcode or QR code) that contains information that may be read and processed. This glyph may contain encoded information, or it may contain an address or other identifier that the system may use to retrieve information from a source that corresponds to the address or identifier.

In addition to the image, in some embodiments additional information may be retrieved from the card via electronic data transfer. This may occur, for example, by receiving data that is encoded on the card's magnetic strip, or in a computer-readable memory and/or embedded chip such as would be present in a smart card.

Example methods for parsing information are described in U.S. Pat. No. 7,860,312, to Handley et al., entitled “System and Method for Identifying and Labeling Fields of Text Associated with Scanned Business Documents;” U.S. Patent Application Publication No. 2004/0096102, filed by Handley et al., entitled “Methodology for Scanned Color Document Segmentations;” U.S. Pat. No. 6,807,304 to Loce et al., entitled “Feature Recognition Using Loose Gray Scale Template Matching;” and U.S. Pat. No. 7,119,924 to Prabhakar et al., entitled “Detection and Segmentation of Sweeps in Color Graphic Images,” the disclosures of which are herein incorporated by reference.

In an embodiment, one or more keys associated with at least a portion of captured ID image and/or meta data may be used to interrogate a local and/or remote database to retrieve related patient information. As used in this document, a key is a captured data element having a format that matches a known category of information, and which is used to search a database for related information that corresponds to a data point of the known category. For example, a key may be a birth date having a format of ##/##/#### or ##-XXX-####. Related information may include patient medical history, prescription information, physician information, and other such information. In certain embodiments, the retrieved information may be stored into a patient record for future reference.

At step 315, an insurance card from a patient may be received and an image of the insurance may be captured at step 320. In some embodiments, the insurance card may be received by a staff member. The staff member then may capture an image of the insurance card using an image capture device (not shown here). In certain other embodiment, the patient may be asked to present the insurance card to an image capture device directly. In some embodiments, the image capture device may include a barcode scanner, a card reader, a camera, or a card scanner. The image of the complete insurance card may be captured, or a portion of the insurance card. It will be understood to those skilled in the art that prior art image capturing modules may be modified for use with the present disclosure. In certain embodiments, the captured image may be stored into a patient database for future reference.

A patient insurance card may include human readable information, a magnetic strip, barcode, memory device, or other information bearing means. An image may be captured by scanning a barcode on the insurance card, photographing the insurance card, scanning the insurance card, swiping a magnetic strip on the insurance card or otherwise reading the insurance card. Variations will be apparent in light of this disclosure, and the present invention is not intended to be limited to any one such configuration.

Next at step 325, corresponding insurance meta data may be extracted from the image captured at step 320. The patient meta data may include patient's full name, subscriber or insurance ID and other pertinent information, such as group number, insurance provider name, insurance provider contact information and co-pay. Meta data may be extracted or parsed using known techniques such as image processing and OCR, or any other suitable pattern recognition technique now or hereafter known to those of skill in the art (as discussed previously).

For example, the image of the scanned insurance card may be interrogated using conventional OCR to translate the image into a searchable ASCII file of data fields. The ASCII data of each field can then be cross-referenced to a look-up table (e.g., stored in a network database or locally) having current known information for all the insurance companies that are accepted by the healthcare provider. Such cross-referencing may be used to help identify the type of information in each field, and prevent errors. For instance, one field may contain “Blue Cross” or “Tufts” or the like. Cross referencing these terms with the database would identify the patient's insurance company. Another field might contain “Identification No.”, indicating that an adjacent field just to the right includes the patient's identification number. Similarly, another field might contain “Group No.”, indicating that an adjacent field just to the right includes the plan or group code. Similarly, another field might contain a “$”, indicating that an adjacent field just to the right includes the co-pay. As another example, an image may include a QR code that contains information that may be read and processed.

In an embodiment, one or more keys associated with at least a portion of captured insurance card image and/or meta data may be used to interrogate a local and/or remote database to retrieve related patient coverage information. For example, a key may be a group number from captured information, or from a bitmap file associated with captured information, of a patient's insurance card, and may be used to obtain related patient coverage information. Related information may include insurance plan information, covered services information, covered drugs information, and other similar coverage information. In certain embodiments, the retrieved information may be stored into a patient record for future reference. In an embodiment, the key may be used to cross-reference the retrieved information to a look-up table having current known information for all the insurance companies that are accepted by the healthcare provider (as discussed above).

At step 330, meta data extracted from a patient ID card and insurance card may be assembled into a single patient data file that serves as an electronic medical record. A patient data file is a digital file containing data relating to a new or existing patient. For example, a patient data file may include information representing a patient name, date of birth, contact information, insurance provider information and an associated insurance ID and/or the like. In an embodiment, the extracted information may be assembled into a patient data file using a template. For example, extracted information may be inserted into one or more designated locations within a template. Alternatively, extracted information may be assembled into a patient data file without the use of a template.

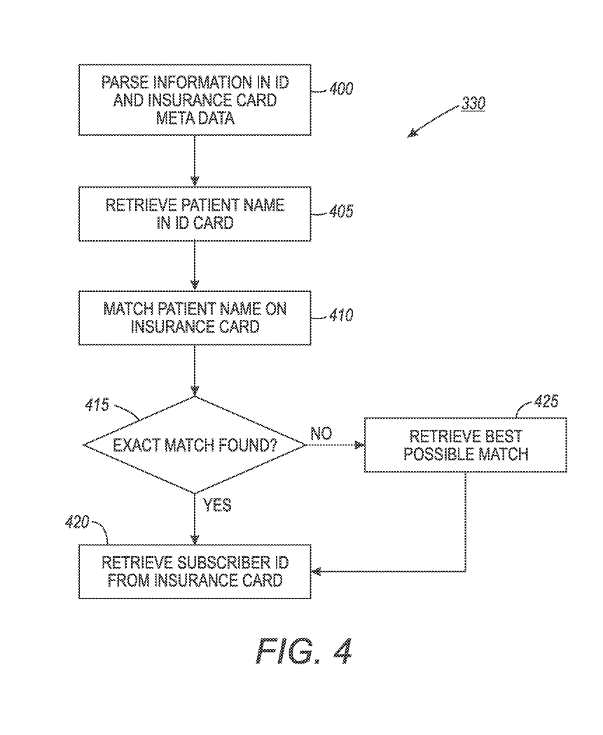

As shown in FIG. 4, step 330 includes retrieving a subscriber ID number associated with a patient name on the patient ID card. In an embodiment, at step 400, meta data extracted from a patient ID card and insurance card may be parsed for information, and a patient name from the ID card may be retrieved at step 405. At step 410, information from an insurance card may be parsed to determine which, if any, of the names on the insurance card matches a name on the patient ID card. In certain embodiments, if at step 415, it is determined that an exact name match was found, then a subscriber ID associated with the matched name from the insurance card information may be retrieved directly at step 420.

Alternatively, in certain embodiments, at step 415, it may be determined that an exact match of a patient name from the ID card was not found on the insurance card. Other methods may then be employed at step 425 to retrieve an associated subscriber ID for a patient. The other methods, for example, may include using language mapping techniques now or hereafter known to those of skill in the art to retrieve a similar closest name match. For example, language mapping may include mapping a portion of the patient name to a name variant, replacing the mapped portion of the patient name with the name variant, and identifying a name on the insurance card that matches the patient name with the name variant. Another example may include compiling a list of possible nicknames and/or hyphenated names associated with the patient name retrieved from a patient's ID card and parsing the insurance card for a match or near match, which may use any now or hereafter known matching techniques such as approximate string matching.

In another embodiment, relevant numerical fields such as a patient's date of birth (retrieved from an ID card) may be matched to retrieve a corresponding subscriber ID. Other numerical fields may include social security number. Alternatively, in some embodiments, more than one of the data fields may be compared. For example, if an exact name match was not found, date of birth and sex information may be matched simultaneously to retrieve a subscriber ID from an insurance card. Additional and/or alternate techniques may be used within the scope of this disclosure.

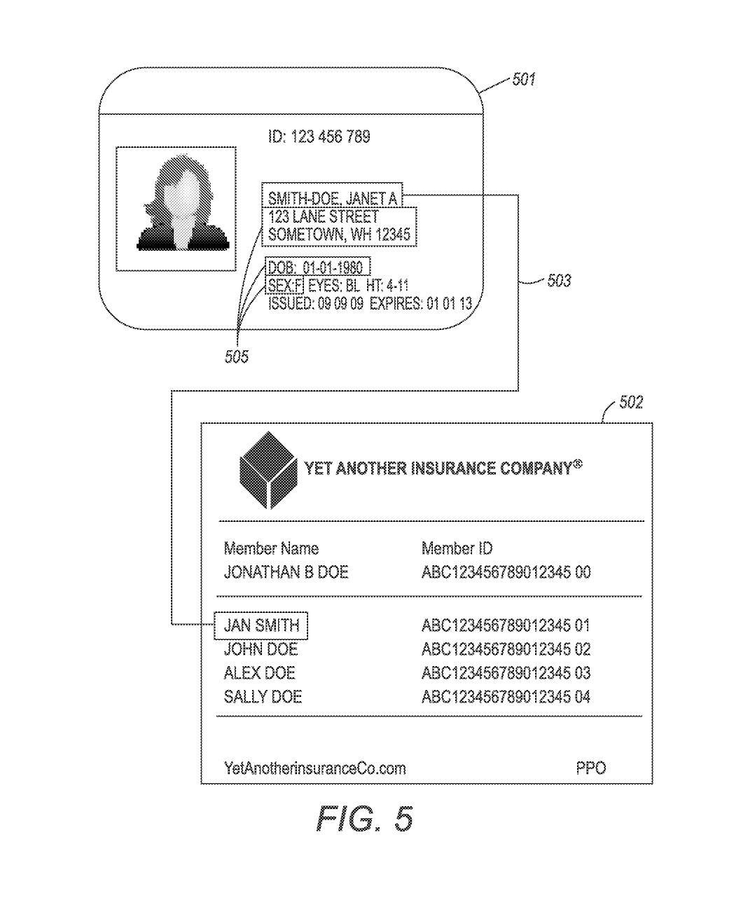

FIG. 5 shows an embodiment where no exact name match can be found for the name Janet A. Smith-Doe (retrieved from a patient photo ID card 502) on an insurance card 502. Methods such as those described above from step 425 may be employed to retrieve the closest name match and the corresponding subscriber ID (503). In one embodiment, a list of possible nick names and/or hyphenated names associated with Janet A. Smith-Doe may be complied which may include a nick name Jan Smith. The name Jan Smith may then be matched on the insurance card 502, and an associated subscriber ID retrieved. In yet another embodiment, date of birth and/or sex from the photo ID card 501 of a patient may be matched to retrieve a subscriber ID.

As shown in FIG. 3, the data assembled at step 330 (including a subscriber ID) may then be presented to a patient at step 335 for review and verification. The data may be presented electronically using a display screen or printed for a patient. The patient may be asked to confirm the accuracy of the retrieved information, and may be given an opportunity to edit (e.g., add, delete, modify) the information as needed. In one embodiment, each piece of information is presented to the patient, and the patient can confirm the accuracy of each piece by selecting a “Yes” button. If “No” is selected for a piece of information, then that particular data field may be edited. Numerous data presentation and editing schemes can be used here. The insurance information may also be transmitted to the insurance provider for verification thereby allowing the healthcare provider to assess eligibility and plan benefits information.

After verification the assembled data may be stored and used to create a new patient electronic medical record, or it may create an update of an existing record, at step 340.

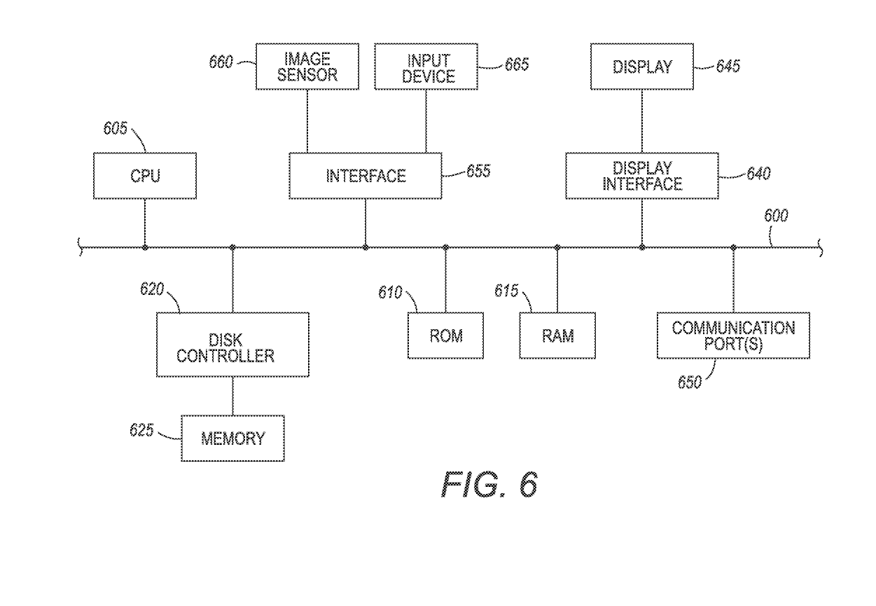

FIG. 6 depicts an example of internal hardware that may be used to contain or implement the various computer processes and systems as discussed above. For example, the user electronic device and/or service provider system as discussed above may include hardware architecture such as that illustrated in FIG. 6. An electrical bus 600 serves as an information highway interconnecting the other illustrated components of the hardware. CPU 605 is a central processing unit of the system, performing calculations and logic operations required to execute a program. CPU 605, alone or in conjunction with one or more of the other elements, is a processing device, computing device or processor as such terms are used within this disclosure. As used in this document and in the claims, the term “processor” may refer to a single processor or any number of processors in a set of processors. Read only memory (ROM) 610 and random access memory (RAM) 615 constitute examples of memory devices.

A controller 620 interfaces with one or more optional memory devices 625 that serve as data storage facilities to the system bus 600. These memory devices 625 may include, for example, an external or internal disk drive, a hard drive, flash memory, a USB drive or another type of device that serves as a data storage facility. As indicated previously, these various drives and controllers are optional devices. Additionally, the memory devices 625 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 610 and/or the RAM 615. Optionally, the program instructions may be stored on a non-transitory, computer readable medium such as a compact disk, a digital disk, flash memory, a memory card, a USB drive, an optical disc storage medium, and/or other recording medium.

An optional display interface 640 may permit information from the bus 600 to be displayed on the display 645 in audio, visual, graphic or alphanumeric format. Communication with external devices may occur using various communication ports 650. A communication port 650 may be attached to a communications network, such as the Internet, a local area network or a cellular telephone data network.

The hardware may also include an interface 655 which allows for receipt of data from input devices such as an imaging sensor 660 of a scanner or other input device 665 such as a keyboard, a mouse, a joystick, a touchscreen, a remote control, a pointing device, a video input device and/or an audio input device.

Examples of systems include the Xerox WorkCenters. The elements of image reading modules in various embodiments are known and are disclosed in, for example, U.S. Pat. Nos. 6,850,730 and 6,744,536, the disclosures of which are each incorporated herein by reference in their entirety. An image sending module includes programming instructions that send data representing a received document to an external recipient via a communications port.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of creating a patient record, comprising:
by an imaging device, receiving an image of an identification card;
by the imaging device, receiving an image of a healthcare insurance card that bears multiple covered person names and, for each covered person name, an insurance identification code;
by one or more processors:
extracting, from the image of the identification card, a name of a patient;
extracting, from the image of the healthcare insurance card, the covered person names;
determining which of the covered person names corresponds to the name of the patient and selecting the determined covered person name as a current patient;
extracting, from the image of the healthcare insurance card, the insurance identification code that corresponds to the current patient; and
in response to selecting the determined covered person name as the current patient and extracting the insurance identification code that corresponds to the current patient, automatically creating an electronic patient record that includes the name and insurance identification code for the current patient.

2. The method of claim 1, wherein determining which of the covered person names corresponds to the patient name comprises, for at least one of the covered person names:
determining that the covered person name is not an exact match with the name of the patient;
mapping a portion of the covered person name to a name variant;
replacing the mapped portion of the covered person name with the name variant; and
determining whether the name of the patient matches the covered person name with the name variant.

3. The method of claim 1, wherein determining which of the covered person names corresponds to the patient name comprises:
identifying at least two of the covered person names as possible matches with the name of the patient;
extracting, from the image of the identification card, a date of birth for the patient;
accessing an external data source to identify a record that includes both the date of birth and one of the possible match covered person names; and
using the covered person name from the identified record as the name of the current patient.

4. The method of claim 1, wherein determining which of the covered person names corresponds to the patient name comprises:
identifying at least two of the covered person names a possible matches with the name of the patient;
extracting, from the image of the identification card, a date of birth and a sex for the patient;
accessing an external data source to identify a record that includes the date of birth, the sex and one of the possible match covered person names; and
using the covered person name from the identified record as the name of the current patient.

5. The method of claim 1, wherein the identification card is selected from a group comprising a driver's license, a prescription card, a Medicare card, a Medicaid card, a medical identification card, and a business card.

6. The method of claim 1, further comprising, by one or more of the processors:
identifying a key in the image of the identification card;
using the key to retrieve corresponding patient information from a database; and
incorporating the retrieved information into the electronic patient record.

7. The method of claim 6, further comprising:
using the key to cross reference a look up table to identify a type of insurance information retrieved; and
including the type of insurance information retrieved in the electronic patient record.

8. The method of claim 1, further comprising displaying the electronic patient record to the patient and prompting the patient to verify the electronic patient record.

9. A patient record creation system comprising:
an imaging device;
one or more processors; and
a non-transitory computer-readable medium, operably connected to the processor, containing programming instructions that when executed by the one or more processors, cause the system to:
receive, from the imaging device, an image of an identification card for a patient,
receive, from the imaging device, an image of an insurance card for the patient,
extract, from the image of the identification card, a name of the patient,
extract, from the image of the healthcare insurance card, a plurality of covered person names,
identify one of the covered person names that corresponds to the name of the patient,
extract, from the image of the healthcare insurance card, an insurance identification code that corresponds to the identified covered person name,
automatically create an electronic patient record for the patent that includes the identified covered person name and the insurance identification code, and
store the electronic patient record in a data storage facility.

10. The system of claim 9, wherein the instructions to identify one of the covered person names that corresponds to the name of the patient comprise instructions to, in response to determining that none of the covered person names is an exact match with the name of the patient;
map a portion of the name of the patient to a name variant;
replace the mapped portion of the name of the patient with the name variant; and
identify one of the covered person names that matches the name of the patient with the name variant.

11. The system of claim 9, wherein the instructions to identify one of the covered person names that corresponds to the name of the patient comprise instructions to, in response to identifying two or more covered person names that are possible matches with the name of the patient;
extract, from the image of the identification card, a date of birth for the patient; and
use the date of birth to select one of the covered person names as the one that corresponds to the name of the patient.

12. The system of claim 9, wherein the instructions to identify one of the covered person names that corresponds to the name of the patient comprise instructions to, in response to identifying two or more covered person names that are possible matches with the name of the patient;
extract, from the image of the identification card, a date of birth for the patient and a sex identification for the patient; and
use the date of birth and the sex identification to select one of the identified covered person names as the one that corresponds to the name of the patient.

13. The system of claim 9, wherein the identification card is selected from a group comprising a driver's license, a prescription card, a Medicare card, a Medicaid card, a medical identification card, and a business card.

14. The system of claim 9, wherein programming instructions further comprise programming instructions that when executed cause the system to:
identify a key in the image of the identification card;
use the key to retrieve corresponding patient information from a database; and
incorporate the retrieved information into the electronic patient record.

15. The system of claim 9, wherein the programming instructions further comprise programming instructions that when executed, cause the system to:
identify a key in the image of the insurance card;
use the key to retrieve corresponding insurance information from a database; and
incorporate the retrieved information into the electronic patient record.

16. The system of claim 15, wherein the programming instructions further comprise programming instructions that when executed, cause the system to:
use the key to cross reference a look up table to identify a type of insurance information retrieved; and
include the type of insurance information retrieved in the electronic patient record.

17. The system of claim 9, further comprising a display, and wherein the programming instructions further comprise programming instructions that when executed by the one or more processors, cause the display to present the patient electronic record to the patient and prompt the patient to verify the patient electronic record.

18. The system of claim 9, wherein the imaging device comprises at least one of the following:
a barcode scanner;
a camera;
a scanner; and
a magnetic strip reader.

19. A method of creating a patient record, comprising:
by an imaging device, receiving an image of an identification card;
by the imaging device, receiving an image of a healthcare insurance card that bears one or more covered person names and, for each covered person name, an insurance identification code;
by one or more processors:
extracting, from the image of the identification card, a name of a patient;
extracting, from the image of the healthcare insurance card, the one or more covered person names;
determining whether one or more of the covered person names corresponds to the name of the patient and selecting the determined covered person name as a current patient, wherein determining whether one or more of the covered person names corresponds to the name of the patient comprises at least one of the following:
for at least one of the covered person names, mapping a portion of the covered person name to a name variant, replacing the mapped portion with the name variant, and determining whether the name of the patient matches that covered person name with the name variant, or
extracting a date of birth for the patient from the image of the identification card, accessing an external data source to identify a record that includes both the date of birth and one of the possible match covered person names, and using a name from the identified record as the name of the current patient;
extracting, from the image of the healthcare insurance card, the insurance identification code that corresponds to the current patient; and
in response to selecting the determined covered person name as the current patient and extracting the insurance identification code that corresponds to the current patient, automatically creating an electronic patient record that includes the name and insurance identification code for the current patient.

20. The method of claim 19, further comprising, by one or more of the processors:
identifying a key in the image of the identification card;
using the key to retrieve corresponding patient information from a database; and
incorporating the retrieved information into the electronic patient record.
